(19) United States
(12) Patent Application Publication
(10) Pub. No.: US 2020/0365022 A1
(43) Pub. Date: Nov. 19, 2020

(54) STOP OR GO DECISION AID

(71) Applicant: Devon Wayne Woodyard, Tijeras, NM (US)

(72) Inventor: Devon Wayne Woodyard, Tijeras, NM (US)

(21) Appl. No.: 16/413,552

(22) Filed: May 15, 2019

(51) Int. Cl. G08G 1/0962; G06K 9/00; G08G 1/052; B60W 30/095

(52) U.S. Cl. CPC G08G 1/09623; G06K 9/00825; B60W 30/0953; G06K 9/00818; G08G 1/052; G06K 9/00798

(57) ABSTRACT

A decision aid can help a driver decide whether or not to stop at an intersection upon observing a yellow light. The decision aid is positioned at an advisory stopping distance from a stopping threshold. The driver can stop before reaching the stopping threshold if the driver's vehicle has not yet passed the decision aid. If the driver has passed the decision aid then the driver is unlikely to be able to stop safely before the stopping threshold if traveling at or over the speed limit. The advisory stopping distance can be based on a specified speed, specified deceleration, and specified recognition and reaction time.

### TECHNICAL FIELD

Embodiments are generally related to road markings and roadway safety.

### BACKGROUND

Novice and elderly drivers are more prone to traffic accidents than experienced drivers. One cause of such accidents is a lack of familiarity with stopping distances and uncertainty regarding when it is safe to stop for a traffic light and when it is best to proceed through the intersection.

Most drivers are well acquainted with the decision to stop for or to run through a yellow light. Even experienced drivers often make the wrong choice, sometimes running through an intersection or entering an intersection when cross traffic has a green light. Traffic engineers do their best to ensure that drivers have enough time to react, but traffic engineers cannot control driver's reactions. Systems and methods that help drivers, particularly novice drivers, make the best decision when approaching an intersection are needed.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is therefore an aspect of the embodiments that a roadway can be marked with a decision aid to help drivers determine whether to stop at or pass through an intersection. A decision aid marking a roadway can be placed an advisory stopping distance from a stopping threshold. The stopping threshold can be a crosswalk, an intersection, or a stop line. Stop lines are heavy lines that are often painted on a roadway as an indicator that stopped vehicles should remain behind the stop line. The advisory stopping distance can be based at least in part on a specified speed, a specified deceleration, and a specified recognition and reaction time.

Roadways are marked with speed limits and the specified speed can be the speed limit or can be slightly higher, such as 5 MPH (miles per hour) above the posted speed limit. Traffic engineers often measure the speed of traffic on roadways. The specified speed can be the average speed or the median speed of traffic. Using the statistical definition, half of the traffic goes faster than the median speed and half goes slower. To add a safety buffer, a speed that only 40% or 30% of traffic exceeds can be selected instead of the median. In most cases, the specified speed should be no lower than but perhaps higher than the speed limit, in other words, the speed limit would be the lower bound of the specified speed. For example, traffic engineers measuring driver's actual speeds may find that most drivers speed at certain places. At those places, it may be unwarranted to use the speed limit as the specified speed because most drivers are going faster. The specified speed can instead be set higher based on measured speed data. As such, a general rule can be that the specified speed be the speed limit (as a lower bound) or the speed that only 25% of traffic exceeds (to account for rampant speeding at certain laces), whichever is higher.

The specified deceleration should be selected based on the deceleration typical of a novice driver if the decision aid is primarily focused on helping novice drivers. Note that novice and elderly drivers behave similarly with respect to deceleration and times for reaction and response. Deceleration can be achieved through some form of braking such as when the driver presses the brake pedal or releases the accelerator pedal. Vehicles can brake using the traditional friction brakes of most current cars, using regenerative braking available with electric drive trains, or engine braking such as occurs when a driver releases the accelerator of an internal combustion powered vehicle. Although many cars can decelerate at near 1 g (32 ft/sec**2), drivers rarely brake that hard. Decelerations between 20 and 25 ft/sec**2 are more common for experienced drivers while novice drivers tend to decelerate less aggressively. A specified deceleration of 15 ft/sec**2 is better for novices, perhaps a number in the range of 15 ft/sec**2 to 20 ft/sec**2.

Regarding units of measure, the principles and embodiments discussed herein apply equally as well when expressed using other units of measure such as the metric system. Here, United States customary units are used. Distance can be expressed in feet, aka ft. Time can be specified in seconds, aka sec. Speed or velocity can be specified in feet per second, aka ft/sec. Acceleration and deceleration can be specified in feet per second per second, aka ft/sec**2. Those practiced in mathematics or physics are familiar with these units for distance, time, velocity, and acceleration. As an example of translating units, 1 mile per hour (MPH) equals 1.467 ft/sec.

Reaction and response time accounts for the amount of time that it takes for a driver to notice a need to stop and to apply the brakes. A one second reaction and response time can be used for experienced drivers. Other drivers need more time with that time ranging up to two seconds. For novice drivers, a 1.5 sec reaction and response time can account for inexperience, distraction, and other factors. As such, a reaction and response time between 1.4 sec and 2.1 sec can accurately reflect the reaction and response time of a novice driver.

The decision aid can take many forms. It can be a roadside sign. It can be a line, pattern, or text painted on the road or in some other manner fixed in place on the road. The decision aid can be a polymer such as tape or a cutout pattern that can be fixed to the road using adhesives, heat, or pressure. The decision aid can be a reflector set into or attached to the roadway. The decision aid can be a rumble strip. The decision aid can be a combination of the aforementioned decision aids.

A further benefit of the stop or go decision aid is that witnesses can inform first responders and emergency personnel that they saw the driver braking before or after the decision aid. Such observations can help resolve liability, help investigators estimate speed, and provide other benefits.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an intersection with a decision aid in accordance with aspects of the embodiments;

FIG. 2 illustrates selecting an advisory stopping distance in accordance with aspects of the embodiments;

FIG. 3 illustrates an intersection with multiple decision aids in accordance with aspects of the embodiments;

FIG. 4 illustrates a high-level flow diagram of setting a decision aid to a roadway in accordance with aspects of the embodiments; and

FIG. 5 illustrates a high-level flow diagram of a driver enjoying the benefit of a decision aid in accordance with aspects of the embodiments.

### DETAILED DESCRIPTION

The particular values and configurations discussed in these non-limiting examples can be varied and are cited merely to illustrate at least one embodiment and are not intended to limit the scope thereof.

For a general understanding of the present disclosure, reference is made to the drawings. In the drawings, like reference numerals have been used throughout to designate identical elements.

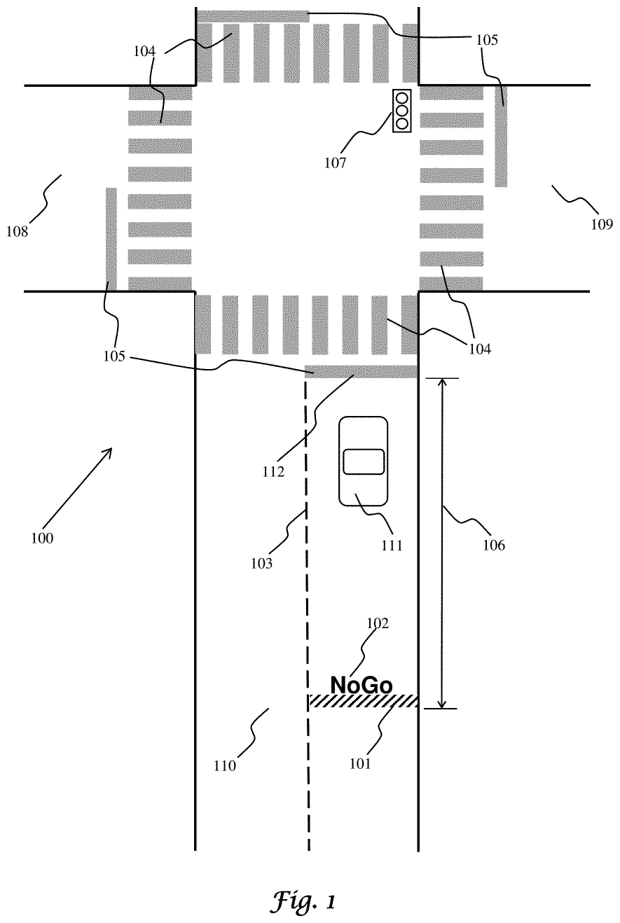

FIG. 1 illustrates an intersection 100 with a decision aid 101, 102 in accordance with aspects of the embodiments. Roadways 108, 109, 110 meet at intersection 100. The roadways have crosswalks 104 and stop lines 105. A stop line 105 is a line on the roadway 108, 109, 110 indicating where vehicles 111 should stop until clear to enter the intersection 100. A vehicle 111 should stop behind the stop line 105, “behind” meaning the stop line 105 should be between the vehicle 111 and the intersection 100. The stop line 105 is therefore an example of a stopping threshold because vehicles 111 should, if required to stop, stop behind the stopping threshold. In FIG. 1, the stop line 105 has been selected as the stopping threshold 112. The stopping threshold 112 is in front of the vehicle 111 and is between the vehicle 111 and the intersection 100. Crosswalks 104 can also be stopping thresholds because vehicles 111 should stop behind crosswalks 104. For this reason, when both stop lines 105 and crosswalks 104 are present the stop lines 105 are generally behind the crosswalks 104. In all cases, the intersection 100 can be selected as a stopping threshold because vehicles 111 should never stop within an intersection 100.

The roadway 110 has a centerline 103 and a traffic light 107. In keeping with United States standards, the traffic light 107 has red, yellow, and green indicators. Red indicates do not enter the intersection (“stop”). Green indicates that it is permissible to enter the intersection. When the traffic light 107 is about to turn red, it transitions from green to yellow, thereby warning drivers that the light is about to turn red. It is the yellow light that can confuse drivers because they do not know how quickly the traffic light 107 will turn red and may be uncertain if their car can safely stop before entering the intersection.

The roadway 110 is marked with a decision aid 101, 102. This particular decision aid has a pattern 101 and text 102. The decision aid 101, 102 is positioned before the stopping threshold 112 which means that the vehicle 111 reaches the decision aid 101, 102 before it reaches the stopping threshold 112 or intersection 100. The advisory stopping distance 106 has been calculated based on a specified speed, a specified deceleration, and a specified recognition and reaction time. A driver having a recognition and reaction time no more than the specified recognition and reaction time can bring a vehicle to a stop within the advisory stopping distance if the vehicle is traveling at or below the specified speed and decelerates at the specified deceleration or at a larger deceleration.

The decision aid can be a roadside sign. The decision aid can be lines, text, or patterns painted on the roadway using paint, including epoxy paint. The decision aid can be a polymer, such as white tape, fixed to the roadway to thereby form lines, text, or patterns. The decision aid can be one or more reflectors arranged on and attached to the roadway. The decision aid can be a rumble strip. Those familiar with driving on roads are familiar with the aforementioned markings and signage that can be used for marking roadways with decision aids. Those familiar with road construction or maintenance are familiar with a variety of techniques for fixing markings to roadways.

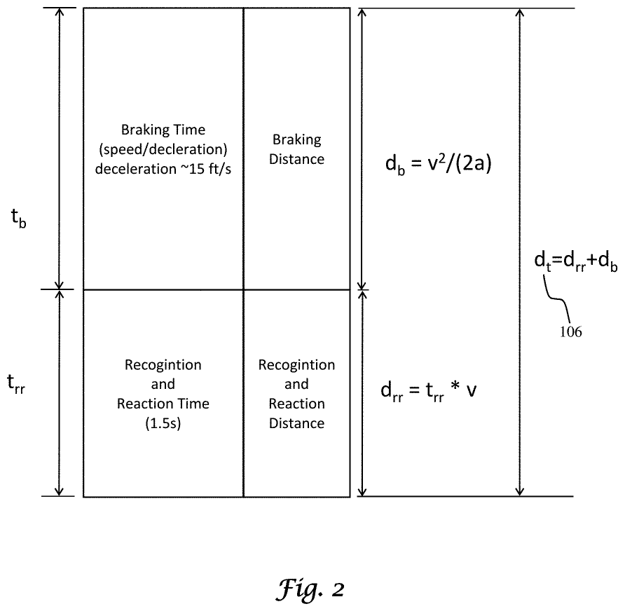

FIG. 2 illustrates selecting an advisory stopping distance in accordance with aspects of the embodiments. Drivers require a certain amount of time in which to recognize a stimulus or indicator and a further amount of time to react. This is known as the recognition and reaction time, tᵣᵣ. Different people have different tᵣᵣ. A one second tᵣᵣ is a good estimate for an attentive and experienced driver with more time required as other factors come into play. A 1.5 second tᵣᵣ is a good estimate for novice or elderly drivers. More generally, novice and elderly drivers tend to have a tᵣᵣ in the range of 1.4 seconds to 2.1 seconds.

Braking time, t_{b}, depends on a vehicle's speed, the vehicle's ability to decelerate, and the driver's ability to apply the brakes in a safe and confident manner. For novice drivers, the deceleration is between 14 ft/sec and 20 ft/sec with 15 ft/sec being a value commonly used in calculating estimated braking distances for novice and elderly drivers. Decelerations in the range of 20 ft/sec to 25 ft/sec are often used for experienced attentive drivers. That range can be expressed algorithmically as at least 20 feet per second per second (ft/sec**2) and no greater than 25 ft/sec**2.

The breaking distance, dₜ, is therefore a combination of the recognition and reaction distance, dᵣᵣ, and the braking distance, d_{b}. The recognition and reaction distance can be calculated as dᵣᵣ=tᵣᵣ*v where v is the specified speed. The braking distance can be calculated as d_{b}=v²/(2a) where a is the deceleration (all numbers are positive). The advisory stopping distance 106 is therefore dₜ=dᵣᵣ+d_{b}.

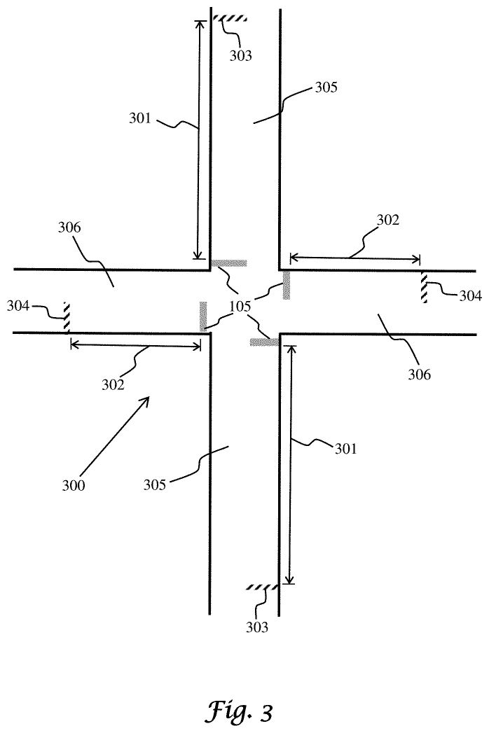

FIG. 3 illustrates an intersection 300 with multiple decision aids 303, 304 in accordance with aspects of the embodiments. Roadway 305 has a higher specified speed than roadway 306. As such, advisory stopping distance 301 is longer than advisory stopping distance 302. The stop lines 105 have been selected as the stopping thresholds. Decision aid 304 is advisory stopping distance 302 from its respective stopping threshold, which is the stop line 105 between the decision aid 304 and the intersection 300. Decision aid 303 is advisory stopping distance 301 from its respective stopping threshold, which is the stop line 105 between the decision aid 303 and the intersection 300.

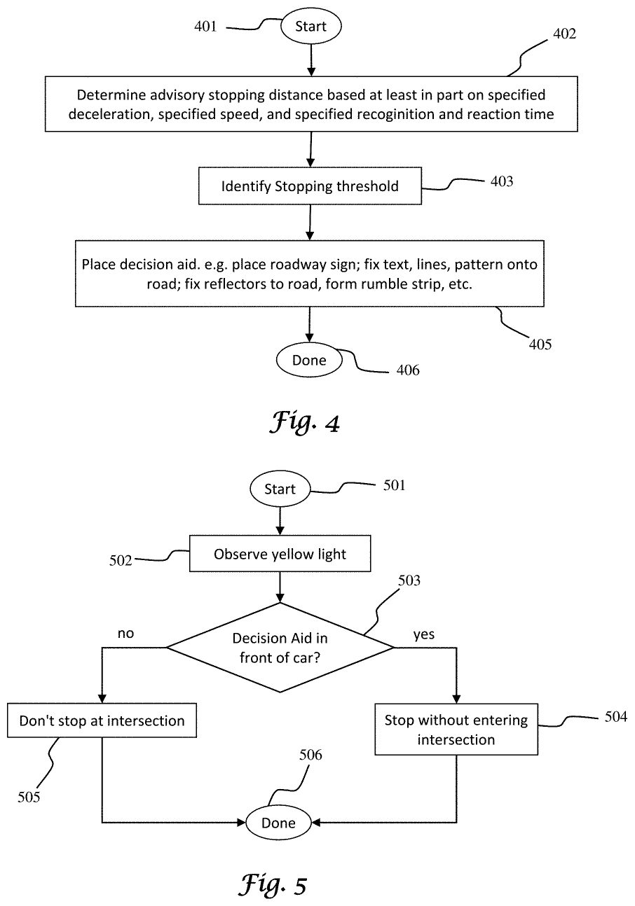

FIG. 4 illustrates a high-level flow diagram of setting a decision aid to a roadway in accordance with aspects of the embodiments. A method for marking a roadway with a plurality of decision aids can include the steps shown in FIG. 4. After the start 401 an advisory stopping distance is determined 402. When determining the advisory stopping distance, the advisory stopping distance can be based at least in part on a specified speed and a specified deceleration. The advisory stopping distance can also be based at least in part on a recognition and reaction time. A stopping threshold is identified 403. As discussed above, identifying the stopping threshold can be selecting a stop line, a crosswalk, an intersection (more precisely, the line where the roadway enters the intersection), or some other boundary as the stopping threshold. A decision aid is placed 405 at the advisory stopping distance before the stopping threshold. Then the process is done 406.

FIG. 5 illustrates a high-level flow diagram of a driver enjoying the benefit of a decision aid in accordance with aspects of the embodiments. After the start 501, the driver observes that a traffic light is yellow 502. The traffic light being yellow, the driver should stop if possible and safe. That driver's choice is made at decision block 503. If the decision aid is in front of the car, then the driver stops without entering the intersection 504, hopefully before reaching the stopping threshold. If the decision aid is not in front of the car, then the driver does not stop at the intersection 505. Then the process is done 506.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A system comprising:
a decision aid marking a roadway and placed at an advisory stopping distance from a stopping threshold, wherein the advisory stopping distance is based at least in part on a specified speed, a specified deceleration, and a specified recognition and reaction time.

2. The system of claim 1 wherein the decision aid is a roadside sign.

3. The system of claim 1 wherein the decision aid is fixed to the roadway.

4. The system of claim 1 wherein the decision aid is painted on the roadway.

5. The system of claim 1 wherein the decision aid is a polymer fixed to the roadway.

6. The system of claim 1 wherein the decision aid comprises a reflector fixed to the roadway.

7. The system of claim 1 wherein the decision aid is a rumble strip.

8. The system of claim 1 wherein the specified deceleration is greater than 14 feet per second per second (ft/sec**2) and less than 20 ft/sec**2.

9. The system of claim 1 wherein the specified recognition and reaction time is greater than 1.4 seconds and less than 2.1 seconds.

10. The system of claim 1 wherein the specified deceleration is at least 20 feet per second per second (ft/sec**2) and no greater than 25 ft/sec**2.

11. A method comprising:
determining an advisory stopping distance based at least in part on a specified deceleration and a specified speed;
identifying a stopping threshold; and
fixing a decision aid to a roadway at the advisory stopping distance before the stopping threshold.

12. The method of claim 11 wherein the advisory stopping distance is also based at least in part on a specified recognition and reaction time.

13. The method of claim 11 wherein the decision aid is a roadside sign.

14. The method of claim 11 wherein the decision aid is fixed to the roadway.

15. The method of claim 11 wherein the decision aid is painted on the roadway.

16. The method of claim 11 wherein the decision aid is a polymer fixed to the roadway.

17. The method of claim 11 wherein the decision aid comprises a reflector.

18. The method of claim 11 wherein the decision aid is a rumble strip.

19. The method of claim 11 wherein the specified deceleration is greater than 14 feet per second per second (ft/sec**2) and less than 20 ft/sec**2, and wherein the specified recognition and reaction time is greater than 1.4 seconds and less than 2.1 seconds.

20. A method for marking a roadway with a plurality of decision aids, the method comprising:
determining an advisory stopping distance based at least in part on a specified deceleration, a specified speed, and a specified recognition and reaction time;
identifying a stopping threshold wherein the stopping threshold is an intersection of the roadway, a crosswalk, or a stop line;
fixing the plurality of decision aids to the roadway at the advisory stopping distance before the stopping threshold;
wherein the plurality of decision aids comprise a roadside sign, paint painted on the roadway, a polymer fixed to the roadway, a reflector, and a rumble strip; and
wherein the specified deceleration is greater than 14 feet per second per second (ft/sec**2) and less than 20 ft/sec**2, and wherein the specified recognition and reaction time is greater than 1.4 seconds and less than 2.1 seconds.
